(19) United States
(12) Patent Application Publication
(10) Pub. No.: US 2006/0064492 A1
(43) Pub. Date: Mar. 23, 2006

(54) Systems and methods for smart communication

(75) Inventor: Andrew J. Hirsch, Austin, TX (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Information and Communication Mobile, LLC

(21) Appl. No.: 10/944,352

(22) Filed: Sep. 17, 2004

(51) Int. Cl. G06F 15/16

(52) U.S. Cl. 709/227

(57) ABSTRACT

In some embodiments, systems and methods for smart communication include a server that facilitates smart communication between users. Users involved in a communication session using a first set of devices may, for example, easily, quickly, and/or automatically establish a second communication session between the users, where the second communication session may be conducted using one or more other devices associated with the users.

### TECHNICAL FIELD

The present disclosure relates generally to systems and methods for communication, and more particularly to systems and methods for smart communication.

### BACKGROUND

Communication sessions between users are often conducted using many types of communications devices. Users may communicate, for example, using wireless telephones, cellular telephones, Personal Digital Assistant (PDA) devices, Personal Computer (PC) devices, pagers, and the like. Communication sessions are typically conducted between similar devices and/or devices that operate through a particular type of medium. One user may utilize a wireless telephone to call another user utilizing a land-line telephone, for example. Similarly, two users may establish an electronic meeting, e-mail, or Voice over Internet Protocol (VoIP) session between two computing devices.

If the participants of a communication session wish to initiate a new session using different devices however, they must separately activate the different devices to initiate the new communication session. Users communicating via e-mail using respective computers, that wish to speak directly with each other for example, must manually initiate a separate voice call using their telephones. Similarly, if a user wishes to send a communication in a medium different than that associated with the current communication session, the user must separately activate a different device to initiate a different communication session in the other medium.

Accordingly, there is a need for systems and methods for improved communication, and particularly for smart communication, that address these and other problems found in existing technologies.

### SUMMARY

Methods, systems, and computer program code are therefore presented for providing smart communication.

According to some embodiments, systems, methods, and computer code are operable to receive an indication from a first device associated with a first user during a first communication session between the first device and a second device associated with a second user. Embodiments may further be operable to initiate, based at least in part on the indication, a second communication session between a third device associated with the first user and a fourth device associated with the second user.

According to some embodiments, systems, methods, and computer code are operable to conduct, at a first device associated with a first user, a first communication session with a second device associated with a second user. Embodiments may further be operable to provide, to a server, an indication associated with initiating a second communication session between a third device associated with the first user and a fourth device associated with the second user.

With these and other advantages and features of embodiments that will become hereinafter apparent, embodiments may be more clearly understood by reference to the following detailed description, the appended claims and the drawings attached herein.

### BRIEF DESCRIPTION OF THE DRAWINGS

FIG. 1 is a block diagram of a communication system;

FIG. 2 is a block diagram of a system according to some embodiments;

FIG. 3 is a block diagram of a system according to some embodiments;

FIG. 4 is a flowchart of a method according to some embodiments;

FIG. 5 is a block diagram of a system according to some embodiments;

FIG. 6 is a flowchart of a method according to some embodiments; and

FIG. 7 is a block diagram of a system according to some embodiments.

### DETAILED DESCRIPTION

Some embodiments herein are associated with “communication”. As used herein, the term “communication” may refer to any information, data, and/or signal that is provided, transmitted, received, and/or otherwise processed by an entity, and/or that is shared or exchanged between two or more people, devices, and/or other entities.

As used herein, the terms “information” and “data” may be used interchangeably and may refer to any data, text, voice, video, image, message, bit, packet, pulse, tone, waveform, and/or other type or configuration of signal and/or information. Information may be or include information packets transmitted, for example, in accordance with the Internet Protocol Version 6 (IPv6) standard as defined by “Internet Protocol Version 6 (IPv6) Specification” RFC 1883, published by the Internet Engineering Task Force (IETF), Network Working Group, S. Deering et al. (December 1995). Information may, according to some embodiments, be compressed, encrypted, and/or otherwise packaged or manipulated in accordance with any method that is or becomes known or practicable.

In addition, some embodiments described herein are associated with an “indication”. As used herein, the term “indication” may be used to refer to any indicia and/or other information indicative of or associated with a subject, item, entity, and/or other object and/or idea. As used herein, the phrases “information indicative of” and “indicia” may be used to refer to any information that represents, describes, and/or is otherwise associated with a related entity, subject, or object. Indicia of information may include, for example, a code, a reference, a link, a signal, an identifier, and/or any combination thereof and/or any other informative representation associated with the information. In some embodiments, indicia of information (or indicative of the information) may be or include the information itself and/or any portion or component of the information. In some embodiments, an indication may include a request, a solicitation, a broadcast, and/or any other form of information gathering and/or dissemination.

Some embodiments described herein are associated with a “communication session”. As used herein, the phrase “communication session” may refer to any instance and/or occurrence of a receipt, transmittal, exchange, and/or sharing of information associated with the communication between two or more parties. A communication session may include, for example, an e-mail transmittal, receipt, and/or exchange, an Instant Messaging (IM) session, a voice call (e.g., over a Public Switched Telephone Network (PSTN), a cellular network, or VoIP), a file upload, download, and/or exchange, and/or any combination thereof. Communication sessions may include continuous, periodic, intermittent, and/or any other frequency of communication that is or becomes known or practicable.

Some embodiments described herein are associated with a “communication device” or a “network device”. As used herein, the terms “communication device” and “network device” may be used interchangeably and may generally refer to any device that can communicate via a network. Examples of communications or network devices include a PC, a workstation, a server, a printer, a scanner, a facsimile machine, a copier, a PDA, a storage device (e.g., a disk drive), a hub, a router, a switch, and a modem or a wireless phone. Communication and network devices may comprise one or more communication or network components, such as a Static Random Access Memory (SRAM) device or module, a network processor, and a network communication path, connection, port, or cable.

In addition, some embodiments are associated with a “network” or a “communication network”. As used herein, the terms “network” and “communication network” may be associated with the transmission of messages, packets, signals, and/or other forms of information between and/or within one or more network devices. By way of example, a network may be configured to operate in accordance with the Fast Ethernet LAN transmission standard 802.3-2002® published by the Institute of Electrical and Electronics Engineers (IEEE). In some embodiments, a network may include one or more wired and/or wireless networks operated in accordance with any communication standard that is or becomes known or practicable.

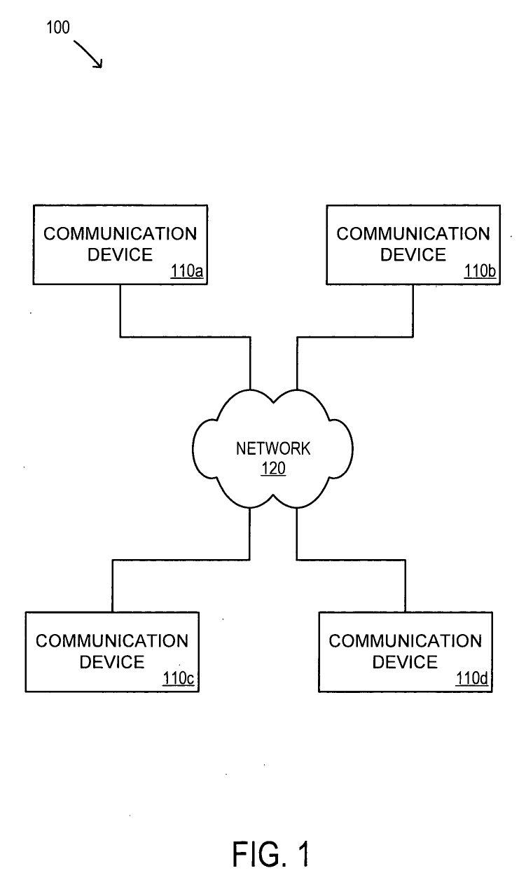

Referring first to FIG. 1, a block diagram of a communication system 100 is shown. The various systems described herein are depicted for use in explanation, but not limitation, of described embodiments. Different types, layouts, quantities, and configurations of any of the systems described herein may be used without deviating from the scope of some embodiments. Fewer or more components than are shown in relation to the systems described herein may be utilized without deviating from some embodiments.

The system 100 may comprise, for example, one or more communication devices 110a-d that may communicate over a network 120. The communication devices 110a-d may be or include any quantity, type, and/or configuration of devices that are or become known or practicable. In some configurations, one or more of the communication devices 110a-d may be associated with one or more users. A different user may, for example, be associated with each of the separate communication devices 110a-d. The various users may, for example, utilize their respective communication devices 110a-d to communicate with one or more of the other users over the network 120. In some configurations, the network 120 may include multiple networks associated with various types of communication mediums. The network 120 may include, for example, one or more Bluetooth®, PSTN, cellular, IP, and/or other wired or wireless networks or sub-networks. Communication sessions may be conducted between any or all of the communication devices 110a-d.

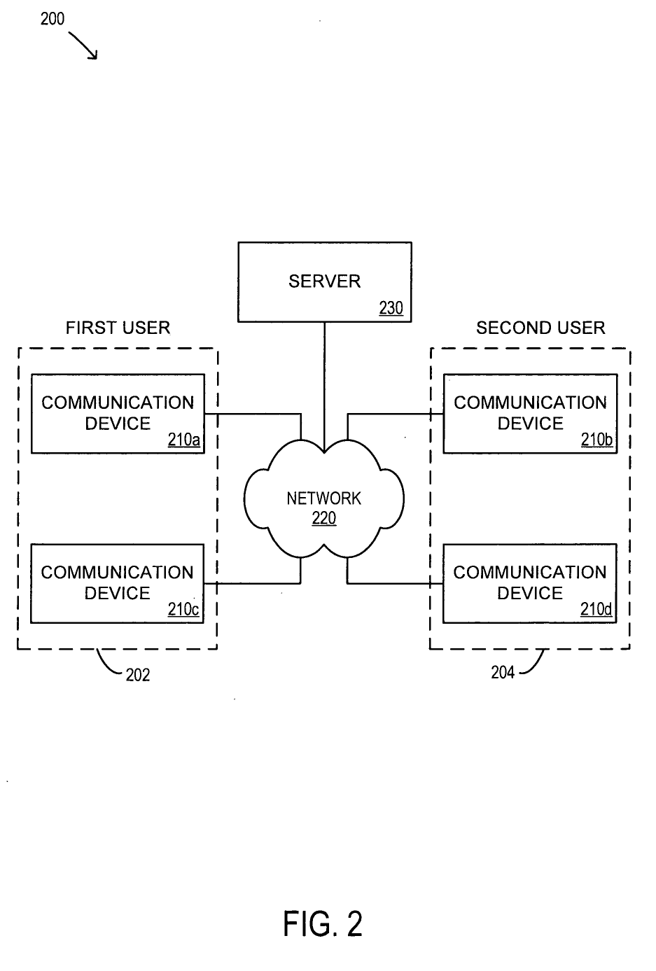

Referring in more detail to FIG. 2, a block diagram of a system 200 according to some embodiments is shown. The system 200 may include, according to some embodiments, one or more users 202, 204 (e.g., a first user 202 and a second user 204), one or more communication devices 210a-d, a network 220, and/or a server 230. Any communication device 210a-d may, according to some embodiments, be in communication with any other communication device 210a-d and/or with the server 230 (e.g., via the network 220). In some embodiments, the components 210, 220 of the system 200 may be similar in configuration and/or functionality to the similarly-named components described in conjunction with FIG. 1. In some embodiments, fewer or more components than are shown in FIG. 2 may be included in the system 200.

According to some embodiments, some and/or all of the communication devices 210a-d may be associated with either or both of the first user 202 and/or the second user 204. As shown in FIG. 2, for example, two communication devices 210a, 210c may be associated with the first user 202, and two communication devices 210b, 210d may be associated with the second user 204. In some embodiments, the communication devices 210a-d may be configured to communicate and/or otherwise receive and/or transmit information in one or more mediums.

For example, the first communication device 210a associated with the first user 202 may be configured to communicate via a first medium (e.g., an IP network), and/or the third communication device 210b associated with the first user 204 may be configured to communicate via a second medium (e.g., a cellular network). In some embodiments, the first communication device 210a associated with the first user 202 may be utilized to establish a communication session (e.g., an IM session or an e-mail session) with the second communication device 210b associated with the second user 204. According to some embodiments, either or both of the first communication device 210a and the second communication device 210b may also communicate with the server 230.

The server 230 may, for example, be or include one or more servers and/or other devices associated with a service provider (e.g., an Internet Service Provider (ISP) or a telecommunications service provider). In some embodiments, any or all of the communication devices 210a-d may register with, logon to, and/or otherwise communicate with the server 230. According to some embodiments, the server 230 may comprise multiple servers and/or multiple devices. The server 230 may, in some embodiments, store and/or otherwise have access to information associated with either or both of the users 202, 204 (and/or associated with their respective communication devices 210a, 210c, 210b, 210d).

In some embodiments, the users 202, 204 may initiate and/or otherwise participate in a communication session utilizing, for example, the first communication device 210a and the second communication device 210b. The communication session may, for example, be conducted in a particular medium. One or both of the users 202, 204 may wish to initiate a new communication session that may, for example, allow the users 202, 204 to communicate via a different medium. According to some embodiments, one of the users 202, 204 (or both of the users 202, 204) may provide an indication associated with the wish to initiate a new communication session.

For example, the first user 202 may provide input to the first communication device 210a that indicates a desire to initiate a new communication session. In some embodiments, the indication may include information identifying different devices and/or mediums through which the new communication session is to be initiated. The first user 202 may indicate, for example, that the new communication session is to be conducted via the third communication device 201c associated with the first user 202. In some embodiments, the indication may also or alternatively specify that the new communication session is to be conducted utilizing the fourth communication device 210d associated with the second user 204. According to some embodiments, the server 230 may facilitate the initiation of the new communication session.

The server 230 may, for example, store and/or otherwise have access to information associated with the users 202, 204 that includes information regarding the communication devices 210a-d associated with the users 202, 204. In some embodiments, the server 230 may receive and/or otherwise identify, access, or determine the indication provided by the first user 202 (and/or any other indication provided by either or both of the users 202, 204). In the case that the indication specifies the devices to be used in establishing the new communication session, the server 230 may, for example, determine the addresses, identities, and/or locations of the desired devices (e.g., communication devices 210c-d), and/or may connect or otherwise couple the desired devices. In some embodiments, the server 230 may determine if either or both of the devices are turned-on or otherwise available.

In the case that the indication specifies a desired medium for the new communication session, the server 230 may, for example, identify one or more devices that are capable of communicating in the desired medium. The server 230 may, according to some embodiments, determine if a communication device 210 associated with each of the users 202, 204 (and/or potentially associated with one of the users 202, 204) is turned-on, available (e.g., within an operable range and/or area), and/or is capable of communication in certain mediums (e.g., a medium desired for the new communication session). The server 230 may determine, for example, that the third and fourth communication devices 210c-d are capable of communicating in the desired medium and are logged-on to the network 220 and/or are logged-on to and/or registered with the server 230.

In some embodiments, the server 230 may automatically establish a new communication session between the appropriate devices (e.g., the third and fourth communication devices 210c-d). The server 230 may also or alternatively provide information to either or both of the third and fourth communication devices 210c-d that allows and/or facilitates the devices 210c-d to establish the new communication session. According to some embodiments, the information provided by the server 230 may make any or all of the communication devices 210a-d “aware” of the presence, availability, and/or capabilities of any or all of the other devices 210a-d.

In some embodiments, such as in the case that the indication specifies a particular type of desired medium, the server 230 may direct information in the desired medium to a device capable of communicating in the desired medium. For example, in the case that the first user 202 wishes to send a communication in a medium different than that currently being used in the communication session between the first and second communication devices 210a-b, the server 230 may automatically determine whether either or both of the devices 210a-b are capable of utilizing the desired medium. In some embodiments, an attempt to send a communication in a different medium may, for example, be an indication that is processed by the server 230.

In the case that the second communication device 210b is not capable of receiving information in the desired medium, for example, the server 230 may automatically determine another device associated with the second user 204 (and/or potentially associated with the second user 204) that is capable of receiving the communication. The fourth device 210d may, in some embodiments, be determined by the server 230 to be available for receipt of the communication, and the desired communication in the different medium may be directed to the fourth communication device 210d (e.g., instead of to the second communication device 210b). In some embodiments, the fourth communication device 210d may be a communication device that is determined to be located in a particular area.

The second communication device 210b (and/or any other communication device 210) may, for example, be configured to identify and/or provide location information associated with the second communication device 210b and/or the second user 204. The second communication device 210b may, according to some embodiments, include a Global Positioning System (GPS) and/or other location-related component that provides location information to the server 230. The server 230 may, for example utilize the location information to determine one or more fourth communication devices 210d that are disposed within an area near the second user 204. In some embodiments, the desired communication in the second and/or different medium may be directed to the fourth communication device 210d and/or the second user 204 may be provided with information associated with the fourth communication device 210d (e.g., the location, owner, cost to use and/or rent, and/or capabilities of the fourth communication device 210d).

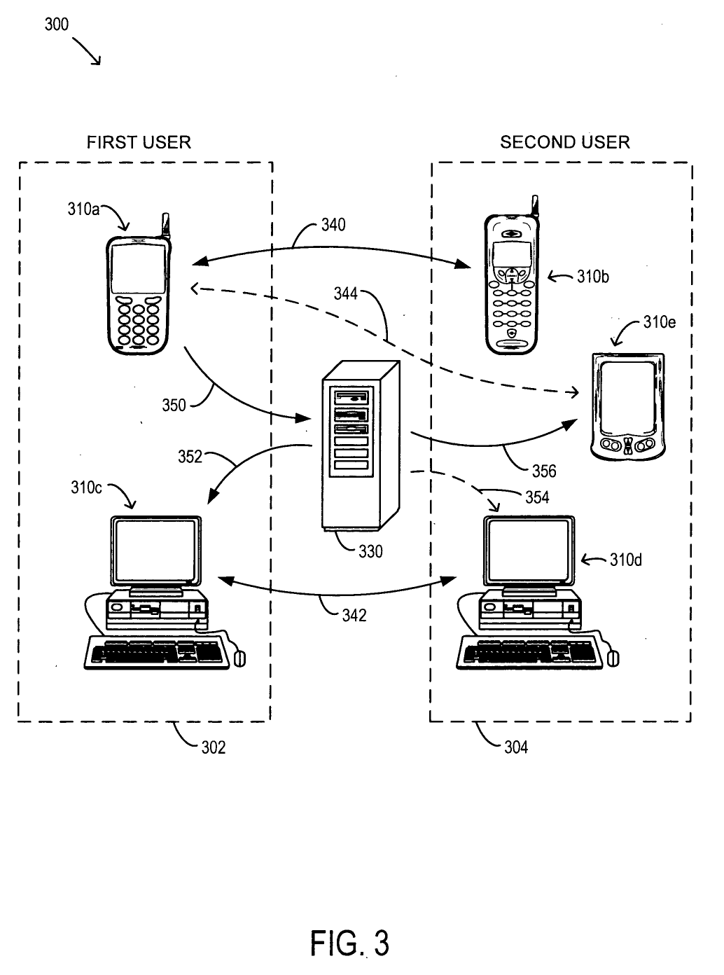

Turning now to FIG. 3, a block diagram of a system 300 according to some embodiments is shown. The system 300 may, for example, be associated with and/or may be similar to the systems 100, 200 described in conjunction with any of FIG. 1 and/or FIG. 2. The system 300 may include, according to some embodiments, one or more users 302, 304 (e.g., a first user 302 and a second user 304), one or more communication devices 310a-e, a server 330, and/or various communication sessions 340, 342, 344 and/or various communication paths 350, 352, 354, 356. In some embodiments, the components 302, 304, 310, 330 of the system 300 may be similar in configuration and/or functionality to the similarly-named components described in conjunction with any of FIG. 1 and/or FIG. 2. In some embodiments, fewer or more components than are shown in FIG. 3 may be included in the system 300.

In some embodiments, the first user 302 and the second user 304 may communicate via a first communication session 340. The first communication session 340 may, for example, be conducted utilizing a graphically-enabled cellular telephone 310a associated with the first user 302 and a wireless telephone 310b associated with the second user 304. According to some embodiments, the first communication session 340 may be conducted via a first medium, such as voice (e.g., a telephone call).

The first user 302 (and/or the second user 304) may, according to some embodiments, desire to initiate a second communication session. The first user 302 may, for example, wish to send information to the second user 304 while maintaining privacy. In other words, the first user 302 may not want to provide the information via voice (i.e., the first medium) using the first communication session 340 (e.g., someone else may be listening and/or the information may be confidential). The first user 302 may, according to some embodiments, provide an indication that the second communication session is to be established. The first user 302 may, for example, select an option from a menu on the cellular telephone 310a, speak a pre-defined command, enter a code and/or other pre-defined input sequence, and/or otherwise provide an indication (e.g., pushing a button). In some embodiments, the indication may be provided and/or sent to the server 330.

The server 330 may, according to some embodiments, receive the indication via the communication path 350. The communication path 350 may, for example, represent a direct communication between the cellular telephone 310a and the server 330 and/or may represent a monitoring and/or harvesting of information associated with the first user 302 by the server 330. In some embodiments, the server 330 may process the indication. The server 330 may, for example, determine if the indication includes information associated with the second communication session to be established. The indication may be determined, for example, to specify at least one specific device that is desired to be associated with the second communication session.

The indication may specify, in some embodiments, that the computers 310c-d associated with the users 302, 304 are to initiate an e-mail and/or IP session (e.g., the second communication session 342 shown in FIG. 3). In some embodiments, the server 330 may determine one or more devices that are to be involved in the second communication session 342. In the case that the indication specifies a desired medium for the second communication session 342, for example, the server 330 may identify devices associated with the users 302, 304 (and/or potentially associated with the users 302, 304) that are available and/or capable of conducting the second communication session 342. In some embodiments for example, the server 330 may utilize location information associated with the users 302, 304 and/or the first or second devices (310a-b) to identify one or more other devices (310c-e) that are in an area near the users 302, 304 and/or the first or second devices (310a-b).

For example, the first communication session 340 (e.g., via voice) may be desired to be continued via computers with IP connections (e.g., such as computers 310c-d). The first user 302 may, according to some embodiments, have direct access to and/or otherwise be associated with the computer 310c (e.g., the first user 302 may be at home or in an office). The second user 304 may not, for example, have direct access to and/or be associated with the computer 310d. In other words, the second user 304 may be walking down a street or driving a car, and/or may have forgotten to bring a computing device (such as the PDA 310e). In some embodiments, in the case that the server 330 is provided with location information associated with the second user 304 (and/or the wireless telephone 310b), the server 330 may identify one or more devices such as the computer 310d that are in proximity to (or will be in proximity to) the second user 304.

If the second user 304 is walking by an establishment that offers Internet access and/or rents computer time, for example, the server 330 may determine that the computer 310d (e.g., inside the establishment) is available, near, and/or capable of being used in the second communication session 342. In some embodiments, information associated with the computer 310d such as cost to rent, use, and/or buy, exact location, directions to the location, and/or terms of use may be provided to the second user 304 (e.g., via the wireless telephone 310b). According to some embodiments, the second user 304 may authorize the use of and/or select the computer 310d (e.g., after reviewing how much it will cost and/or how far away it is).

According to some embodiments, the server 330 may initiate the second communication session 342. In the case that the server 330 is associated with an ISP, for example, the server 330 may connect and/or otherwise couple the computers 310c-d (e.g., via an IP session). In some embodiments, the server 330 may facilitate the initiation of the second communication session 342. The server 330 may, for example, provide information to the computer 310c associated with the first user 302 that facilitates the communication between the computers 310c-d. The server 330 may, according to some embodiments, provide the computer 310c of the first user 302 with address, location, and/or other identification or contact information (e.g., an IP address, a Uniform Resource Locator (URL), and/or an e-mail address) associated with the computer 310d of the second user 304. The information may be provided, for example, via the communication path 352, allowing the computer 310c of the first user 302 to initiate the second communication session 342 with the computer 310d of the second user.

In some embodiments, the server 330 may also or alternatively provide information to the computer 310d associated with the second user 304 (e.g., via the information path 354). Address, location, and/or other identification or contact information associated with the computer 310c of the first user 302 may, for example, be provided to the computer 310d of the second user 304. According to some embodiments, the information provided to the computer 310d of the second user 304 may allow the second communication session 342 to be mutually initiated (e.g., between the two computers 310c-d). In some embodiments, the information may cause the computer 310d associated with the second user to automatically accept the next incoming IP session request and/or the next communication request received from the computer 310c of the first user 302.

In some embodiments, the server 330 may establish a new communication session by redirecting some or all communications associated with one of the users 302, 304. The first user 302 may, for example, desire to send a picture and/or other electronic file (e.g., information in a second medium) to the second user 304. The wireless telephone 310b associated with the second user 304 may not, however, be capable of receiving graphics and/or electronic files. In some embodiments, the first user 302 may provide an indication associated with the desire to send the picture to the second user 304.

The first user 302 may, for example, select the picture from a menu on the cellular telephone 310a and further select an option such as “send”, indicating that the picture is to be sent to the second user 304. According to some embodiments, the cellular telephone 310a may include a camera that, when used during a communication session (like the first communication session 340), automatically indicates that the resulting picture (and/or video) is to be sent to the second user 304. In some embodiments, the first user 302 may provide other input to the cellular telephone 310a to indicate that the picture is desired to be sent to the second user 304. According to some embodiments, the indication may be provided and/or sent to the server 330.

In some embodiments, such as in the case that the wireless telephone 310b is not capable of receiving the picture, a new communication session between the first and second users 302, 304 may be established. The server 330 may, for example, receive and/or otherwise identify the indication and may cause and/or facilitate the creation of a new communication session 344. The new communication session 344 may, according to some embodiments, be established between the cellular telephone 310a and a PDA 310e associated with the second user 304. In some embodiments, the server 330 may search for and/or otherwise identify or locate a device associated with (and/or potentially associated with) the second user 304 that is capable of receiving the information in the second medium (e.g., the picture). The server 330 may determine, for example, that the PDA 310e is turned-on and is capable of receiving and/or viewing pictures.

In some embodiments, the picture may be sent, via the new communication session 344, to the PDA 310e of the second user 304. Further communication between the first and second user 302, 304 may continue via the original communication session 340 and/or may proceed via the new communication session 344. According to some embodiments, the communication session 340, 344 through which information is transmitted may be determined (e.g., by the server 330) based on the type of medium that the information is associated with. Any pictures and/or other electronic files may, for example, be exchanged between the cellular telephone 310a and the PDA 310e (e.g., the devices capable of processing such files), while any voice communication may continue to be exchanged between the cellular telephone 310a and the wireless telephone 310b. In some embodiments, the server 330 may relay information to the PDA 310e (e.g., via the communication path 356). The server 330 may also or alternatively provide communication information to the PDA 310e (such as file parameters and/or information associated with the cellular telephone 310a).

According to some embodiments, the server 330 may automatically establish, initiate, terminate, transfer, and/or otherwise manage the communication sessions 340, 342, 344 between the users 302, 304. In some embodiments, such as in the case that information transmitted by the first user 302 is incompatible with a device associated with the second user 304, the server 330 may automatically determine an alternate device associated with the second user 304 that is capable of receiving the information. Communication between the first and second users 302, 304 may, according to some embodiments, be automatically initiated between one or more alternate devices (e.g., from the phone devices 310a-b to the computer devices 310c-d). The server 330 may, for example, store information associated with device capabilities and/or preferences. In some embodiments, the users 302, 304 may register with the server 330 by providing such information to the server 330. In some embodiments, the devices 310 may logon and/or otherwise make their presence known to the server 330 when the devices 310 are turned-on. In such a manner, for example, the server 330 may be “aware” of any devices 310 that are available to initiate new communication sessions.

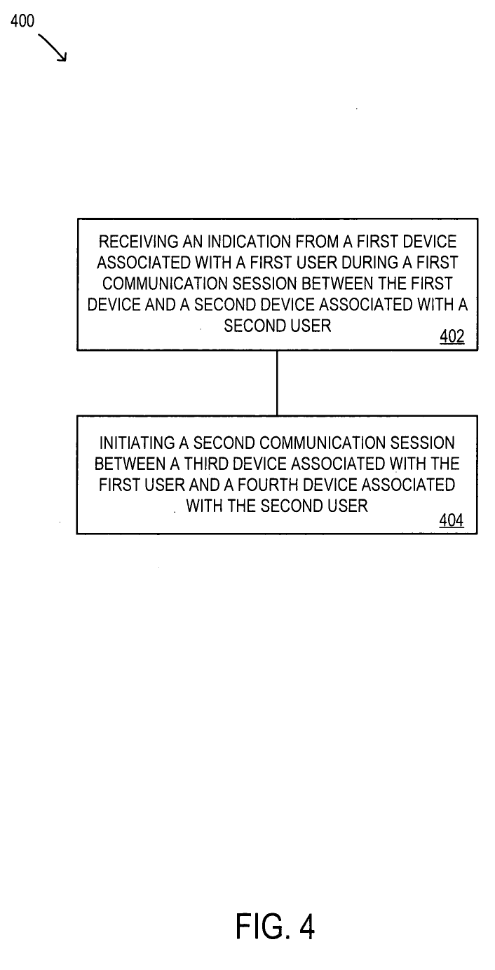

Referring now to FIG. 4, a method 400 according to some embodiments is shown. In some embodiments, the method 400 may be conducted by and/or by utilizing the systems 100, 200, 300 and/or may be otherwise associated with the systems 100, 200, 300 and/or any of the system components described in conjunction with any of FIG. 1, FIG. 2, and/or FIG. 3. The method 400 may, for example, be performed by and/or otherwise associated with the server 230, 330 described herein. The flow diagrams described herein do not necessarily imply a fixed order to the actions, and embodiments may be performed in any order that is practicable. Note that any of the methods described herein may be performed by hardware, software (including microcode), firmware, manual means, or any combination thereof. For example, a storage medium may store thereon instructions that when executed by a machine result in performance according to any of the embodiments described herein.

In some embodiments, the method 400 may begin at 402 by receiving an indication from a first device associated with a first user during a first communication session between the first device and a second device associated with a second user. The first user may, for example, desire to establish a new communication session between the first user and the second user. In some embodiments, the first user may desire to utilize a different device in establishing the new communication session.

For example, the first communication session may be a telephone call between the first and second users (such as the first and second users 202, 204, 302, 304), utilizing telephones associated with each of the users. In the case that the first user desires to send an electronic file (e.g., a program, a data file, a picture, or a movie) to the second user, the telephones may not be capable and/or desirable to exchange information in such a medium (e.g., one or both of the telephones may be limited to voice communications). The first user may, in some embodiments, provide an indication that a second communication session is desired to be established.

The first user may, for example, utilize the telephone (i.e., the first device) to enter input associated with the new communication session. In some embodiments, the first user may select an option from a menu provided by the telephone (e.g., a voice response menu or a graphical menu). According to some embodiments, the first user may enter a pre-defined code and/or sequence associated with establishing a new communication session. In the case that the first user is registered with a service and/or server, for example, a pre-defined input into the telephone may indicate that a new communication session is to be initiated. In some embodiments, the indication may also or alternatively specify one or more specific devices and/or mediums that are to be utilized in the new communication session. According to some embodiments, the indication may be or include information associated with the first communication session. An attempt by the first user to send a communication in the second medium, for example, may be an indication that a new communication session is desired.

In some embodiments, the indication may be received by a server, such as the server 230, 330 described herein. The server may be owned, operated by, and/or otherwise associated with a provider of communication services, for example. According to some embodiments, the server may monitor the first communication session to determine the indication. The server may also or alternatively register and/or otherwise track or identify the first and second devices (e.g., the first and second communication devices 210a-b, 310a-b).

The method 400 may continue at 404, according to some embodiments, by initiating, based at least in part on the indication, a second communication session between a third device associated with the first user and a fourth device associated with the second user. In the case that the indication is received by a server at 402, for example, the server may facilitate and/or initiate the second communication session. In some embodiments, the second communication session may be established in accordance with the indication. Any specified devices, mediums, addresses, and/or other parameters identified by the indication may, for example, be utilized to initiate the second communication session.

In some embodiments, the server may cause the third device to initiate a new communication session with the fourth device. In the case that the first communication session is a voice session and the users (or one of the users) wishes to send an electronic file, for example, the server may determine that computing devices (such as PDA, PC, and/or notebook computing devices) associated with the users are available (e.g., the third and fourth devices). In some embodiments, the server may determine a plurality of devices that are associated with each user and may determine which devices are available (e.g., turned-on or in range) and/or which devices are capable of transmitting or receiving the electronic file. In some embodiments, the server and/or the users may select which devices out of the available devices will be used to conduct the new communication session.

According to some embodiments, such as in the case that the third and fourth devices are specified (e.g., by the indication at 402), available, and/or capable of communicating in a given medium, the server may initiate the second communication session (e.g., the new communication session). The server may, for example, provide the third device with information associated with the fourth device (e.g., an IP and/or e-mail address), and/or cause the third device to initiate a communication session with the fourth device. In some embodiments, the server may also or alternatively provide information to the fourth device. The fourth device may be instructed, for example, to automatically accept the communication attempt made by the third device. In some embodiments, the fourth device may be provided with information associated with the third device so that the fourth device may contact the third device and/or a mutually-initiated communication session may be established.

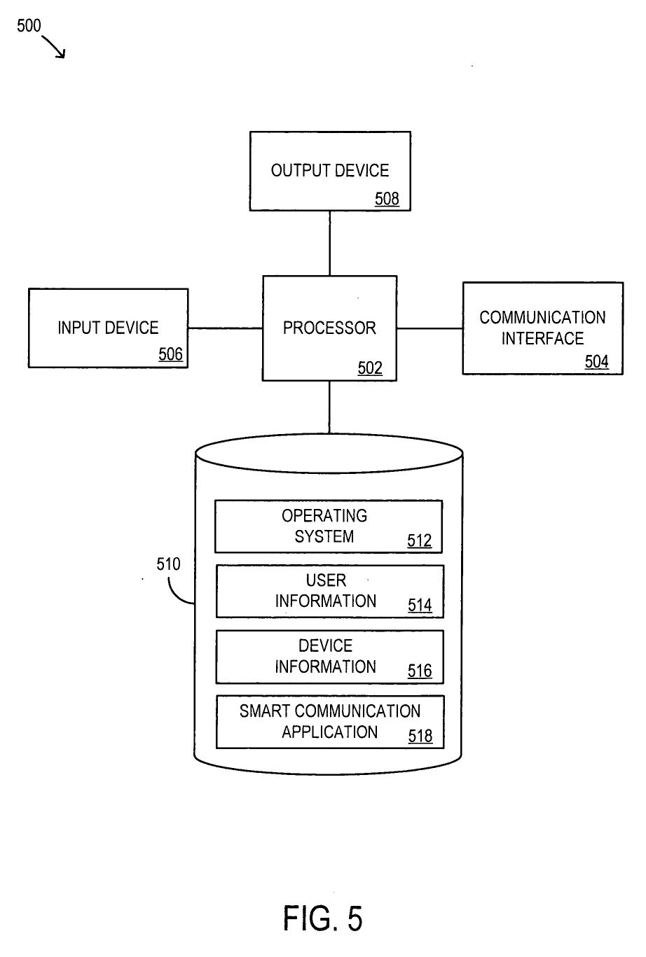

Turning now to FIG. 5, a block diagram of a system 500 according to some embodiments is shown. The system 500 may, for example, be utilized to implement and/or perform the method 400 described herein and/or may be associated with the systems 100, 200, 300 described in conjunction with any of FIG. 1, FIG. 2, and/or FIG. 3. In some embodiments, fewer or more components than are shown in FIG. 5 may be included in the system 500. According to some embodiments, different types, layouts, quantities, and configurations of systems may be used.

In some embodiments, the system 500 may be or include a computer such as a PC, a computer server, and/or a notebook computer. According to some embodiments, the system 500 may be a server such as the server 230, 330 described herein. The system 500 may include, for example, one or more processors 502, which may be any type or configuration of processor, microprocessor, and/or micro-engine that is or becomes known or available. In some embodiments, the system 500 may also or alternatively include one or more communication interfaces 504, one or more input devices 506, one or more output devices 508, and/or a memory device 510, all and/or any of which may be in communication with the processor 502. The memory device 510 may store, for example, an operating system 512, user information 514, device information 516, and/or a smart communication application 518.

The communication interface 504 may be or include any type and/or configuration of communication device that is or becomes known or available. In some embodiments, the communication device 504 may allow the system 500 (and/or the processor 502) to communicate with, for example, one or more communication devices (e.g., communication devices 110, 210, 310). According to some embodiments, the communication interface 504 may be or include a Network Interface Card (NIC) such as an Intel® PRO/1000 MT Desktop Adaptor that operates in accordance with the Fast Ethernet LAN transmission standard 802.3-2002® published by the Institute of Electrical and Electronics Engineers (IEEE), or an Intel® PRO/Wireless 2225BG Network Connection that operates in accordance with the Wireless LAN transmission standard 802.11B/G-1999/2003® published by the IEEE.

The input device 506 may be or include one or more conventional devices such as a keyboard, a mouse, a trackball, etc. The input device 506 may be utilized, for example, by an operator and/or system user to interface with the operating system 512 and/or the smart communication application 518 (e.g., executed by the processor 502), and/or to facilitate the management or establishment of communication sessions in accordance with embodiments described herein. The output device 508 may be or include any type of output device that is or becomes known or practicable, including, but not limited to, a printer, a Cathode Ray Tube (CRT) display device, a Liquid Crystal Display (LCD) device, and/or a Light-Emitting Diode (LED) display device.

The memory device 510 may be or include, according to some embodiments, one or more magnetic storage devices, such as hard disks, one or more optical storage devices, and/or solid state storage. The memory device 510 may store, for example, the operating system 512, user information 514, device information 516, and/or the smart communication application 518. In some embodiments, the smart communication application 518 may store instructions that cause the processor 502 to operate in accordance with embodiments described herein. The smart communication application 518 may, for example, automatically initiate and/or otherwise establish communication sessions between various users and/or communication devices (e.g., through the communication interface 504).

In some embodiments, the smart communication application 518 may utilize either or both of the user information 514 and the device information 516 to facilitate communication between devices. According to some embodiments, the smart communication application 518 may process indications received (e.g., at 402) from communication devices to determine communication sessions that should be automatically established. For example, upon determining an indication associated with a first communication session between a first user and a second user, the smart communication application 518 may utilize the user information 514 to identify one or more devices associated with either or both of the users. In the case that the first communication session is conducted between first and second devices, for example, the smart communication application 518 may identify a third and/or a fourth device that is available and/or desirable to initiate a new communication session.

In some embodiments, the smart communication application 518 may also or alternatively utilize the device information 516. The device information 516 may be utilized, for example, to determine the capabilities of, location of, and/or preferences associated with various devices associated with (and/or potentially associated with) the users. Where a user wishes to send information in a particular medium to another user, for example, the smart communication application 518 may utilize the device information 516 (and/or the user information 514) to automatically determine the appropriate device and/or devices that should be used to initiate a new communication session. The smart communication application 518 may, for example, locate one or more devices that are near one of the users and that are available and/or capable of being used in a new communication session. In some embodiments, the smart communication application 518 may initiate any desired new communication sessions (e.g., at 404), cause the sessions to be initiated, and/or facilitate their initiation.

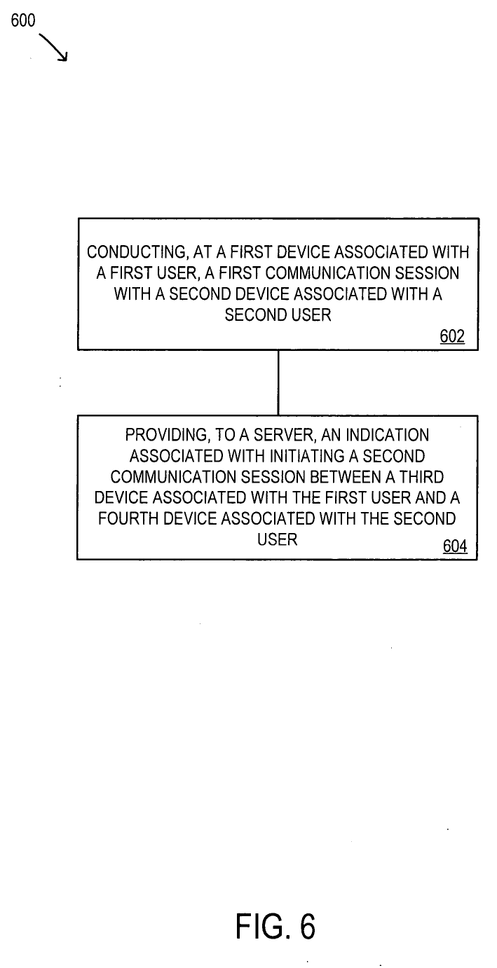

Referring now to FIG. 6, a method 600 according to some embodiments is shown. In some embodiments, the method 600 may be conducted by and/or by utilizing the systems 100, 200, 300 and/or may be otherwise associated with the systems 100, 200, 300 and/or any of the system components described in conjunction with any of FIG. 1, FIG. 2, and/or FIG. 3. The method 600 may, for example, be performed by and/or otherwise associated with the communication devices 110, 210, 310 described herein.

In some embodiments, the method 600 may begin at 602 by conducting, at a first device associated with a first user, a first communication session with a second device associated with a second user. The two users may, for example, conduct a telephone conversation using two telephones. Similarly, the two users may utilize other communication devices such as computers to conduct electronic meeting, e-mail, IM, VoIP, and/or other IP sessions. In some embodiments, more than two users may be involved in the communication session. The first and second users may, for example, be parties to a group call, meeting, and/or other group communication session.

The method 600 may continue, for example, by providing, to a server, an indication associated with initiating a second communication session between a third device associated with the first user and a fourth device associated with the second user. In some embodiments, one or more of the users may wish to communicate via a different medium and/or using one or more different devices. In the case that the first communication session is an IM session conducted between two computers (e.g., the first and second devices), for example, the users may wish to speak directly with each other. The users may desire to initiate a telephone conversation, using third and fourth communication devices (e.g., two telephones), for example. According to some embodiments, an indication of the desire for the telephone conversation (e.g., a second communication session) may be provided to a server (such as the server 230, 330 described herein).

In some embodiments, the indication may comprise input from one or more of the users. The first user may, for example, enter input into the first device to notify the server that the second communication session should be initiated. According to some embodiments, the input may include a menu selection, a code, a reference, an identifier, a request, and/or any other type of information that is indicative of the desire and/or need to initiate a second communication session. In some embodiments, the indication may be or include a communication signal transmitted from the first device to the second device and/or to the server. The indication may, for example, be or include a keyword, command, and/or other configuration of communication associated with the first communication session.

The indication may, according to some embodiments, indicate and/or include information associated with the second communication session that is to be established. The indication may specify, for example, one or more devices that should be utilized to conduct the new communication session. In some embodiments, the indication may specify that the second communication session is to be conducted between a third and a fourth device (associated with the first and second users, respectively). According to some embodiments, the third device may be the same as the first device or the fourth device may be the same as the second device (e.g., only one of the devices from the first communication session may be substituted in the second communication session).

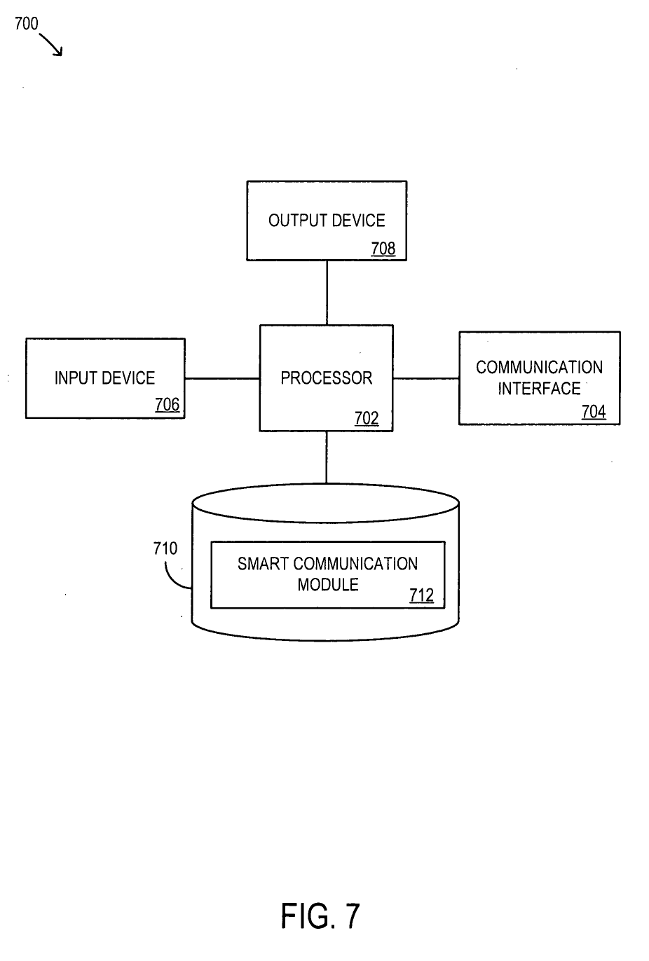

Turning now to FIG. 7, a block diagram of a system 700 according to some embodiments is shown. The system 700 may, for example, be utilized to implement and/or perform the method 600 described herein and/or may be associated with the systems 100, 200, 300 described in conjunction with any of FIG. 1, FIG. 2, and/or FIG. 3. In some embodiments, fewer or more components than are shown in FIG. 7 may be included in the system 700. According to some embodiments, different types, layouts, quantities, and configurations of systems may be used.

In some embodiments, the system 700 may be or include a communication device such as a PC, a PDA, a wireless telephone, and/or a notebook computer. According to some embodiments, the system 700 may be a communication device such as the communication devices 110, 210, 310 described herein. In some embodiments, the system 700 may be a wireless communication device that is used to provide an indication to a server. The system 700 may include, for example, one or more processors 702, which may be any type or configuration of processor, microprocessor, and/or micro-engine that is or becomes known or available. In some embodiments, the system 700 may also or alternatively include a communication interface 704, an input device 706, an output device 708, and/or a memory device 710, all and/or any of which may be in communication with the processor 702. The memory device 710 may store, for example, a smart communication module 712.

The communication interface 704, the input device 706, and/or the output device 708 may be or include any types and/or configurations of devices that are or become known or available. In some embodiments, the components 704, 706, 708 of the system 700 may be similar in configuration and/or functionality to the similarly-named components described in conjunction with FIG. 5 herein. According to some embodiments, the input device 706 may include a keypad, one or more buttons, and/or one or more softkeys and/or variable function input devices. The input device 706 may include, for example, any input component of a wireless telephone and/or PDA device, such as a touch screen and/or a directional pad or button.

The memory device 710 may be or include, according to some embodiments, one or more magnetic storage devices, such as hard disks, one or more optical storage devices, and/or solid state storage. The memory device 710 may store, for example, the smart communication module 712. The smart communication module 712 may be any type of application, module, program, and/or device that is capable of facilitating smart communication. The smart communication module 712 may, for example, include instructions that cause the processor 702 to operate the system 700 in accordance with embodiments as described herein.

For example, the smart communication module 712 may receive input from a user and create an indication that a server utilizes to initiate a second communication session. In some embodiments, the smart communication module 712 may include a Graphical User Interface (GUI) that allows a user of the system 700 to provide input used to formulate the indication. The user may, for example, utilize the GUI of the smart communication module 712 to select one or more devices, mediums, addresses, users, and/or other parameters associated with the creation of a new communication session. In some embodiments, the smart communication module 712 may process the input from the user and/or provide the indication to a server.

According to some embodiments, the smart communication module 712 may be capable of receiving information from the server. The smart communication module 712 may, for example, receive information associated with the initiation of a new communication session and may utilize the information to establish the communication session (e.g., by contacting another device). In some embodiments, the smart communication module 712 may register with and/or logon to the server. The smart communication module 712 may, for example, logon to the server in the case that the system 700 is turned-on and/or otherwise becomes available for communication. The registration may, according to some embodiments, allow the server to identify devices (such as the system 700) that are available for use in establishing communication sessions between users.

The several embodiments described herein are solely for the purpose of illustration. Those skilled in the art will note that various substitutions may be made to those embodiments described herein without departing from the spirit and scope of the present invention. Those skilled in the art will also recognize from this description that other embodiments may be practiced with modifications and alterations limited only by the claims.

What is claimed is:

1. A method, comprising:
receiving an indication from a first device associated with a first user during a first communication session between the first device and a second device associated with a second user; and
initiating, based at least in part on the indication, a second communication session between a third device associated with the first user and a fourth device associated with the second user.

2. The method of claim 1, further comprising:
detecting, at a server, the presence of at least one of the devices.

3. The method of claim 2, wherein the detecting includes:
identifying, by the server, at least one of the devices that is turned-on.

4. The method of claim 1, further comprising:
facilitating, at a server, at least one of the first or second communication sessions.

5. The method of claim 1, further comprising:
providing information associated with at least one of the second or fourth devices to the first device.

6. The method of claim 1, wherein the second and fourth devices are the same.

7. The method of claim 1, wherein the first and third devices are the same.

8. The method of claim 1, wherein the first communication session is conducted in a first medium and the second communication session is conducted in a second medium.

9. The method of claim 1, wherein the indication includes a request to initiate the second communication session.

10. The method of claim 1, wherein the initiating is performed automatically in response to the indication.

11. A method, comprising:
conducting, at a first device associated with a first user, a first communication session with a second device associated with a second user; and
providing, to a server, an indication associated with initiating a second communication session between a third device associated with the first user and a fourth device associated with the second user.

12. The method of claim 11, further comprising:
providing information associated with at least one of the first or third devices to the server.

13. The method of claim 11, further comprising:
receiving information associated with at least one of the second or fourth devices from the server.

14. The method of claim 11, wherein the second and fourth devices are the same.

15. The method of claim 11, wherein the first and third devices are the same.

16. The method of claim 11, wherein the first communication session is conducted in a first medium and the second communication session is conducted in a second medium.

17. The method of claim 11, wherein the indication includes a request to initiate the second communication session.

18. The method of claim 11, further comprising:
determining that a communication signal associated with the first communication session is not compatible with the second device.

19. The method of claim 18, wherein the providing is based at least in part on the determining.

20. A system, comprising:
a memory configured to store instructions;
a communication port; and
a processor coupled to the memory and the communication port, the processor being configured to execute the stored instructions to:
receiving an indication from a first device associated with a first user during a first communication session between the first device and a second device associated with a second user; and
initiating, based at least in part on the indication, a second communication session between a third device associated with the first user and a fourth device associated with the second user.
